(19) United States
(12) Patent Application Publication
(10) Pub. No.: US 2010/0330988 A1
(43) Pub. Date: Dec. 30, 2010

(54) METHOD AND APPARATUS

(75) Inventors: Seppo Kalevi Granlund, Helsinki (FI); Arto Olavi Karppanen, Helsinki (FI)

Correspondence Address: BANNER & WITCOFF, LTD., 1100 13th STREET, N.W., SUITE 1200, WASHINGTON, DC, 20005-4051, US

(73) Assignee: NOKIA CORPORATION, Espoo (FI)

(21) Appl. No.: 12/494,686

(22) Filed: Jun. 30, 2009

(51) Int. Cl. H04W 4/00; H04M 1/00

(52) U.S. Cl. 455/434; 455/550.1

(57) ABSTRACT

A method comprising: receiving in a first mobile communication device information about at least one access network from at least one second mobile communication device; and selecting an access network for use by the first mobile communication device in dependence on said information.

### FIELD OF THE INVENTION

The present invention relates to a method and apparatus.

### BACKGROUND

A communication system can be seen as a facility that enables communication sessions between two or more entities. For example, mobile communication systems provide for communications on wireless interfaces between user equipment and/or other nodes. The communications may comprise, for example, communication of voice, electronic mail (email), text messages, multimedia, other data and so on. Users may thus be offered and provided numerous services via their user equipment. Non-limiting examples of the services include two-way or multi-way calls, data communication or multimedia services or simply an access to a data communications network system such as the Internet.

User equipment which has accessed a system may also be provided broadcast or multicast content. Non-limiting examples of such content include downloads, television and radio programmes, videos, advertisements, various alerts and other information.

A communication system can be provided, for example, by a communication network and one or more compatible user equipment. The communication network may be a large network providing nationwide cover, continent-wide cover, or even global cover. However, the communication network may also be provided by a local network. In a wireless communication system, at least part of the communications, between two nodes, occurs over a wireless link. Examples of wireless systems include public land mobile networks (PLMN), satellite based communication systems and wireless local networks, for example wireless local area network (WLAN).

The user equipment can access the communication system via an access node such as a base station or the like. A feature of wireless systems is that they provide mobility for the users. User equipment can be moved from a cell or the like to another cell in a network. User equipment is also typically allowed to enter into another network.

The communication system and associated user equipment typically operate in accordance with a given standard or standards and/or specifications which set out what the various entities associated with the system are permitted to do and how that should be achieved. For example, the standard or specification may define if a communication device is provided with a circuit switched carrier service or packet switched carrier service or both.

Communication protocols and/or parameters which should be used for the connection are also typically defined.

With the current proliferation of wireless communication, it is not unusual for a particular area to be covered more than one network. However, it can be problematic for a user equipment to make a decision as to which access network should be selected.

### Some Exemplary Embodiments

In one embodiment a method comprises:
receiving in a first mobile communication device information about at least one access network from at least one second mobile communication device; and
selecting an access network for use by the first mobile communication device in dependence on said information.

In another embodiment an apparatus comprises:
at least one processor; and
at least one memory including computer program code, the at least one memory and the computer program code configured to, with the at least one processor, cause the apparatus at least to perform:
selecting an access network for use by a first mobile communication device in dependence on received information about at least one access network, said information being received from at least one second mobile communication device.

In another embodiment an apparatus comprises:
means for receiving in a first mobile communication device information about at least one access network from at least one second mobile communication device; and
means for selecting an access network for use by the first mobile communication device in dependence on said information.

### BRIEF DESCRIPTION OF THE FIGURES

For a better understanding of the present invention and as to how the same may be carried into effect, reference will be made by way of example only to the accompanying Figures which illustrate some embodiments of the invention:

FIG. 1 shows schematically a diagram of a communication system having multiple access networks;

FIG. 2 shows the communication system of FIG. 1 with information shared between user equipment in an ad-hoc network;

FIG. 3 illustrates a situation in which user equipment are relatively close to each other in an ad-hoc network and are relatively far from a base station;

FIG. 4 shows a flow diagram illustrating a method of a first embodiment of the present invention;

FIG. 5 shows a flow diagram of a second method embodying the present invention;

FIG. 6 illustrates in more detail the querying of FIGS. 4 and 5;

FIG. 7 shows in more detail the selection of the network;

FIG. 8 shows schematically user equipment usable in embodiments of the present invention;

FIG. 9 shows in more detail parts of the user equipment of FIG. 8, used in selecting an access network; and

FIG. 10 shows in more detail parts of the user equipment of FIG. 8, used in providing information to a user equipment selecting an access network.

### DETAILED DESCRIPTION OF SOME EMBODIMENTS

In the following description, various specific details are set forth in order to provide an understanding of some embodiments of the invention. It is apparent, however, to one skilled in the art that the embodiments of the invention may be practiced without the specific details or by an equivalent arrangement.

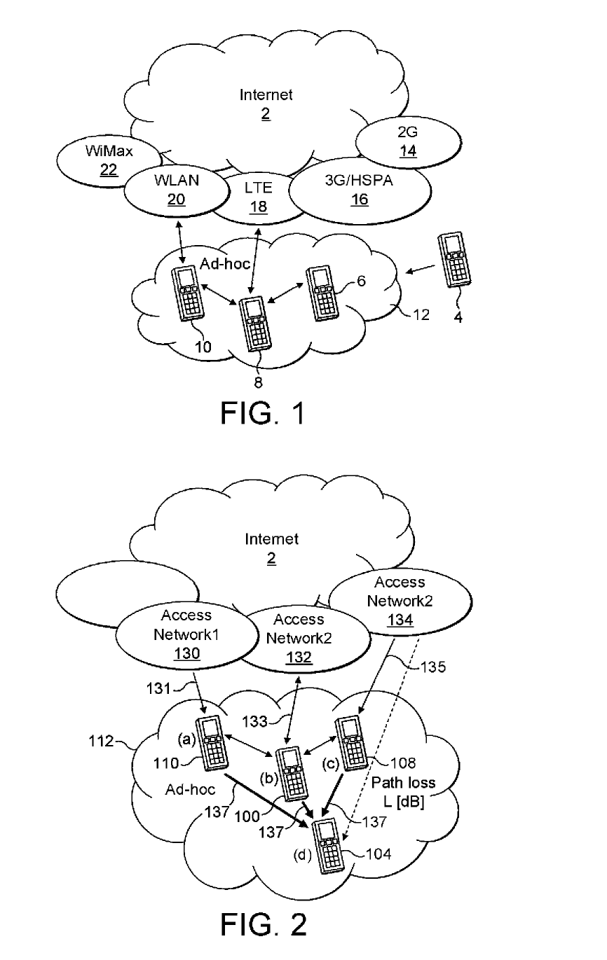

Reference is now made to FIG. 1. FIG. 1 shows an area represented diagrammatically by reference 12 which represents a hot spot area. This hot spot area 12 is served by a number of different access networks. In the example shown in FIG. 1, five different access networks are available. A first access network 14 uses 2G (second generation technology), for example GSM (global system for mobile communication). Another example of a 2G technology is EGPRS (enhanced general packet radio service). A second access network 16 is provided which uses a third generation cellular technology such as WCDMA (wideband code division multiple access) or HSPA (high speed packet access). A third access network 18 is the LTE network (long term evolution) which is the so-called 3.9 generation cellular technology which builds on the 3G standards. The fourth access network 20 is a WLAN (wireless local area network). The fifth access network 22 is a WiMax (worldwide interoperability for microwave access).

Each of these access networks is able to connect on the one hand to the internet 2 and on the other hand to respective user equipment. In the arrangement shown in FIG. 1, there are four user equipments 4, 6, 8 and 10.

It should be appreciated that FIG. 1 shows one embodiment only. In alternative embodiments of the present invention, there may be only two access networks. One or more of the access networks may use the same technology but may for example be provided by different operators or allocated different radio resources, such as frequency or the like. The different access technologies shown in FIG. 1 are by way of example only and any other suitable access network can be additionally or alternatively be used with embodiments of the invention.

In one embodiment of the invention, a method is provided which utilises an ad-hoc network to assist user equipment in access network selection particularly in an area where there is more than one potential access network. Embodiments of the present invention can be used where a user equipment is able to access more than one access network in a particular area. As mentioned above, the access networks may use the same technology or different. Accordingly, in one embodiment of the present invention, the user equipment is able to support two or more access technologies. However, embodiments of the present invention may also be used where a user equipment is able to use a single access technology in an area there are two or more access networks using that same technology.

The coverage with various radio access networks may mean that there is a large amount of radio spectrum and bandwidth which is used in areas with a high density of user equipment. However, it can be problematic for the user equipment to decide which access network to select. In one embodiment of the present invention, the user equipment which are in the area 12 are arranged to setup an ad-hoc network to exchange information between the user equipment in the ad-hoc network. It should be appreciated that the ad-hoc network is between the user equipment. An ad-hoc network may comprise two or more user equipment.

The user equipment are arranged to exchange access coverage and performance information. One example of a message exchange has a request message followed by a response message.

The request message comprises one or more of the following information:
destination for the request message: all devices in range
   the message is broadcast
source: identity information of the device sending the request
message type: radio access information query
hop limit of request propagation—this may be set to any desired value, for example, 0, 1 or 2. The hop value may be even larger than in some embodiments of the invention.

The Response message has one or more of the following information:
destination of the response message: This is the source of the request message
source: identity information of the device sending the response
message type: radio access information response
data: one or more of: network type; network ID; channel; signal strength; signal quality; available capacity; and capacity in use
distance—this may be defined in terms of the number of hops the request took to reach the device providing the response—(propagated hops) services available in the access network to which the device sending the response is attached.

It is possible in alternative embodiments of the invention that an ad-hoc network may be set up between one or more user equipment and one or more access nodes.

In the arrangement shown in FIG. 1 where the geographic hot spot area 12 is served by five different wireless access networks 14 to 22, a first user equipment 4 needs to select at least one of the available access networks. In the scenario shown in relation to FIG. 1, the first user equipment 4 is attempting to make a connection to the internet 2. However, it should be appreciated that this is by way of example only and the user equipment may be making a connection to any suitable destination.

One method for obtaining information for random access is for the user equipment to go through all radio accesses which are supported by the user equipment and measure the related pilot signal strengths or the like from the available access networks. This may mean that several frequency bands have to be scanned. Such a procedure may be time consuming and provide an undesirable delay in access. Further, such a procedure may consume, in some situations, a relatively large amount of battery energy.

In one embodiment of the present invention, an ad-hoc network is set up between the first user equipment 4 and three other user equipment 6, 8 and 10. It should be appreciated that the ad-hoc network can be on any suitable size. In principle, the ad-hoc network can be as small as two or very much larger.

In the ad-hoc network, broadcast messaging is used between the user equipment in the hot spot area in order to share, for example coverage and/or performance information between the user equipment. This may avoid or reduce the need for a particular user equipment to scan through all of the access technologies in the random access phase.

Reference is now made to FIG. 2 which illustrates an embodiment of the present invention.

A first user equipment 104 forms an ad-hoc network with neighbouring user equipment 106, 108 and 110. All of these user equipment are arranged in a common area 112 which may be a hot spot.

The first user equipment 104 wishes to make a connection to the Internet 2 and in this example has three available access networks, a first access network 130, a second access network 132 and a third access network 134. It should be appreciated that there may be less than three access networks or more than three access networks. The access networks may be of the same technology, different technology or a mixture thereof. The access network technologies can be any of the previously mentioned access technologies and/or any other suitable access technology.

In the example, one user equipment 110 has measured the strength of the signal 131 of the first access network 130. Another of the user equipment, user equipment 106, has measured the strength of signal 133 from the second access network 132. Whilst yet another user equipment 108 has measured the strength of the signal 135 of the third access network

In addition or as an alternative to the strength information, if a particular user equipment has received capacity information from one of the access networks, that capacity information may be forwarded to the user equipment which is making the decision about which network to select.

Capacity information maybe useful along the signal strength information. If available the capacity information may include the available channel capacity information and/or the capacity in use. With this information, a device can estimate the free capacity of a certain channel. This mechanism may be used to avoid congestion.

In one alternative embodiment, a more advanced collaborative methods maybe used. The devices may agree on scheduling of access network usage. In this way it is possible to share and balance locally the load of hot spot area access network. The scheduling may depend on the type of network. One example of such scheduling may be a time division type scheduling. Another example may be spreading code scheduling. Other types of scheduling may involve one or more parameter such as time, frequency, spreading code or the like.

In another embodiment, the user equipment may share information on services accessible via the respective access networks. For example, one access network may offer access to a proprietary content store whereas other access networks do not offer access to that store.

The first user equipment 104 sends an enquiry to the neighbouring user equipment. The first user equipment 104 broadcasts the enquiry to the neighbouring user equipment 110, 106 and 108. As an Alternative to broadcasting, the enquiry may also be propagated in an ad hoc network or sent to individual user equipment in the ad hoc network.

It should be appreciated that the signal strength of the user equipment used to broadcast the query is selected to have a relatively short range so that only user equipment which are relatively close by are able to receive that signal.

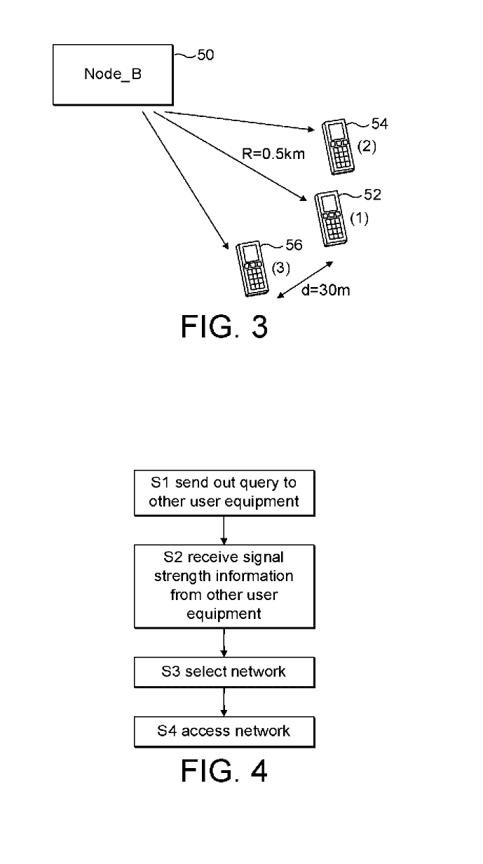

The area over which the user equipment would typically broadcast may vary in accordance with the standard. For example in the scenario illustrated in FIG. 3, the broadcast area may be in the region of a 30 m radius. However, the usable area may depend on the radio type: for example WLAN a radius of greater than 100 m is too much, but for 2G systems, for example GSM (global system for mobile communications) such a radius is usable.

Radio access information concerning WLAN may not be useful beyond 2 or 3 hops but may still be usable with for example 2G access.

Reference is made to FIG. 6 which shows the query process in further detail. The user equipment should send out a query indicating the identity of the user equipment sending the query and an indication of the information which is requested. In one embodiment of the invention, the adhoc network uses the Awarenet (or similar) technology concept. In Awarenet each device is synchronised to the beaconing sent by the Awarenet devices. After synchronizing, a Join message (optional) can be sent for joining the Awarenet community.

With reference to FIG. 6, a user equipment sends a joining message to join the adhoc community in step A1. In step A2, the user equipment synchronises itself to the ad-hoc network. In step A3, the user equipment sends the query message as described previously.

Alternatively, the user equipment may be part of the initial adhoc community and therefore may omit the joining step.

The messages requesting radio access information are sent as broadcast messages, which all the synchronised devices can receive and propagate as required to further devices. These messages are identified by the message type identifier. The response messages are targeted to the device that originated the request as described previously.

The user equipment 110, 106 and 108 are each arranged in response to the query message to respond to the query mechanism. These devices respond to the query mechanism by providing any measured values they have with respect to an access network. The responses sent by the user equipment are represented diagrammatically be references 137. The response which a particular user equipment sends will include the identity of the access network for which they have information and information about the measured signal strengths. It should be appreciated that it is possible that a single user equipment may have information relating to more than one access network. In that situation, the user equipment in question may provide information from one or more of the access networks for which it has information. That information may be provided in a single message or a plurality of messages.

After receiving these responses, the first user equipment 104 uses the received information to decide which access network is likely to provide the best signal. Once that access network has been selected, the user equipment 104 is arranged to start accessing this particular network without measuring the other access networks.

In this regard, reference is made to FIG. 4 which shows a method embodying the present invention.

In step 1, the first user equipment 104 which wants to select an access network is arranged to broadcast a query.

In step S2, the first user equipment 104 is arranged to receive information from other user equipment indicating the measured signal strengths, for example, for several of the access networks.

In step S3, the first user equipment is arranged to select one or more of the networks based on the information which the first user equipment has received from the other user equipment. This may involve selecting the access network for which the signal strengths measured by one of the ad-hoc user equipment is the strongest. However, in other embodiments of the present invention, other criteria may be used to make a decision about a particular network. For example, the first user equipment may have preferences for access technology and/or operator. Accordingly, this may influence the selection of the access network. For example if a measured strength associated with a preferred network technology or operator exceeds a threshold, then that will determine the selection of the particular access network.

In step S4, the first user equipment 104 is arranged to access the selected access network.

In a further embodiment of the present invention, the first user equipment 104 may evaluate the accuracy of the signal estimates which the first user equipment 104 received from the other user equipment. In this regard, reference is made to FIG. 3. FIG. 3 shows an arrangement comprising a node B or base station 50 of an access network. By way of example, this base station is an urban small macro cell base station. There are three user equipment in the coverage area of this base station, the first user equipment 52, the second user equipment 54 and the third user equipment 56. These user equipment are outside and are close to each other, for example with a spacing of around 30 meters. This may be a typical situation for an outdoor hot spot area. The base stations of other access networks and other base stations of the same access network are not shown in FIG. 3.

A WLAN based ad-hoc network is set up between the first and second user equipment and between the first and third user equipment. The following will show that the radio signal values which the three user equipment 52, 54 and 56 received from the base station 50 are similar. Accordingly, if one user equipment measures the signal strength and communicates the value of that signal strength to the other user equipment via the ad-hoc network, then these other two user equipment can use the received signal strength value in access network selection.

Consider the following formula which is used to estimate the signal path loss in an urban macro cell environment:

L=137.4+35.2 log 10(R[km])[dB] (1)

Rough estimates for the path loss L to each device can be determined. Since the user equipment are about 30 meter distance from each other, it can be estimated that the distances from the base station 50 for each of the three user equipment are as follow:

R1=530 m

R2=500 m

R3=470 m

where R1 is the distance to the first user equipment 52, R2 is the distance to the second user equipment 54 and R3 is the distance to the third user equipment 470.

Using equation 1, the corresponding path loss values are estimated as follows:

L1=127.7 [dB]

L2=126.8 [dB]

L3=125.9 [dB]

where L1 is the path loss for the first user equipment 52, L2 is the path loss for the second user equipment 54, and L3 is the path loss for the third user equipment.

The power that is received in a user equipment can be calculated as follows:

P_{received}[dBm]=Pₜᵣₐₙₛ[dBm]−L[dB] (2)

As can be seen from a consideration of this equation, since the path loss values L1, L2 and L3 are relatively similar, it can be seen from equation 2 that the received powers of the three user equipment will be very similar. This calculation shows that in this case, the signal value measured by one of the user equipment may be used as a good estimate for the received signal of other nearby user equipment.

In this example, the first user equipment 52 has measured the signal strength from the base station 50. That first user equipment 52 is able to measure the distance R to the base station. Additionally, the third user equipment 56 can also measure the distance to the first user equipment 52 using the ad-hoc network signal. This is distance D. The ratio of D/R can be used to indicate the accuracy of the method. In other words, if the ratio is small then it is very probable that the base station signal value measured by the first user equipment is also a very good estimate for the corresponding signal value for the third user equipment 56. Put another way, if the distance to the base station is very much greater than the distance between the devices forming the ad-hoc network, then it can be assumed that the user equipment in the same ad-hoc network would measure similar signal values. Accordingly, reliable results can be used if, for example the first user equipment 52 were to use information from the third user equipment 56 to make a determination as to whether or not to select a particular access network.

In a further embodiment of the present invention, the user equipment which needs to make a selection as to a particular access network may measure the strength of the signals which it receives from the other user equipment in the ad-hoc network. This signal strength can be used to indicate to the user equipment making the decision as to the closeness of the user equipment in the ad-hoc network. The user equipment making the decision can choose to, for example ignore information which it has received from user equipment with a relatively low signal strength, choose to use information which is received from user equipment which has a relatively high signal strength and/or use a weighting algorithm in determining from which user equipment the received information should be used. Additionally or alternatively hop count or any other suitable distance information may be taken into account.

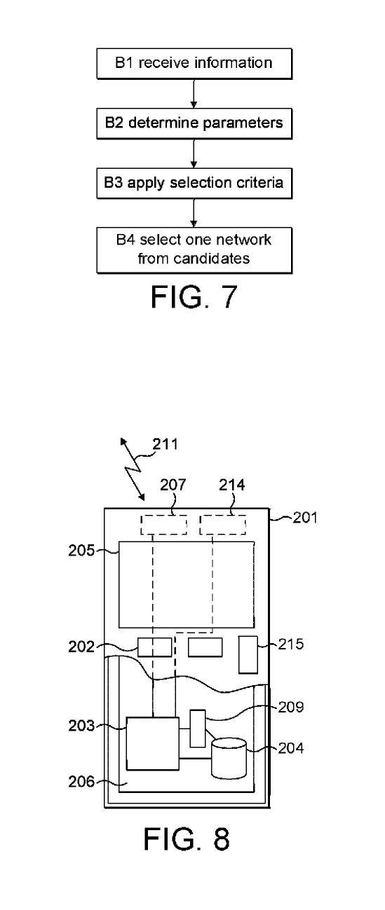

Reference is made to FIG. 7 which shows one example of how a network can be selected.

In step B1, information is received by the device making the decision. This information can take the form of one or more parameters which can be used to make the decision and/or information which is used to calculate, generate or determine one more parameters which can be used to make the decision. (this may at least partially overlap with step S2 or may be in respect of different parameters or information).

In step B2, the device is arranged if necessary to process the received parameter and/or the information. In the case of information, the processing may comprise the calculating, generating or determining of the respective parameter.

In step B3, a selection criteria is applied, using the one or more parameters. One or more of the following parameters may be used in the selection process:
network type (operator)
signal strength
signal quality
capacity
free capacity
distance (hop count or other distance measure)
services available

The selection process may use a simple algorithm or a more complicated process using a plurality of different parameters. The selection process may provide a plurality of candidates.

In step B4, one of the candidates may be selected. In one embodiment, steps B3 and B4 may be provided by a single selection process.

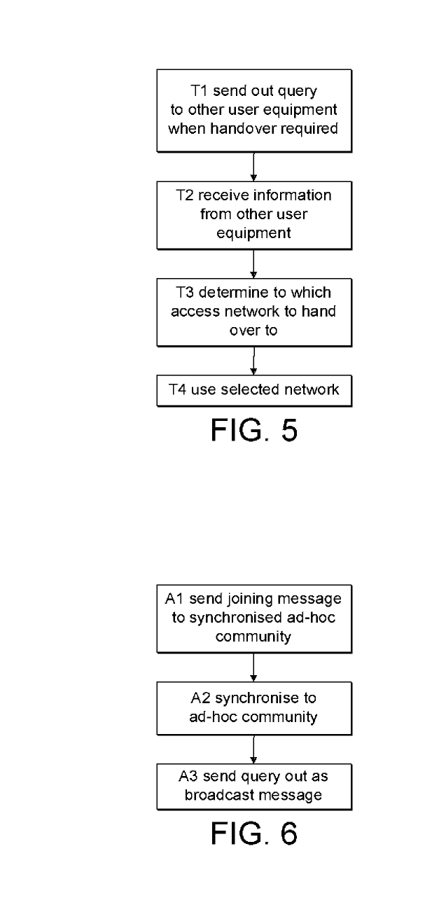

Reference is made to FIG. 5 which shows a further embodiment of the present invention. The previously described embodiments have shown the user equipment making a decision as to which access networks to select. It should be appreciated that alternative embodiments of the present invention can be used where a user equipment needs to hand over.

In this regard, reference is made to FIG. 5 which shows a flow diagram for one embodiment for doing this.

In the first step T1, the user equipment which is to leave a particular access network and/or a particular access node (e.g. a base station) of an access network sends out a query to neighbouring user equipment with which it forms an ad-hoc network. This is similar to step S1.

In step T2, as with step S2, the user equipment is arranged to receive measurement information from neighbouring user equipment in the ad-hoc network.

In step T3, the user equipment is arranged to select a particular access network and/or a particular base station or indeed stay with the same access network dependent on the measurement information. The user equipment can use any suitable decision making access. For example, the user equipment may have a default position in which the user equipment will give the current access network preference over the other networks unless there is at least a predetermined difference between the signal strengths of the current network and one of the other access networks.

In step T4, the user equipment is arranged to use the selected access network.

It should be appreciated that any of the alternatives previously described in relation to the selection of an access network may be applied in this alternative arrangement.

Alternatively or additionally, one embodiment of the invention is used where a user equipment is currently attached to a particular access network and wants to use a new, potentially different service.

In one or more of the above described embodiments, the ad-hoc network may be created using short range radio technology, for example wireless local area network (WLAN) or Bluetooth (trademark). The ad-hoc network may be a mobile ad-hoc network (MANET).

Reference will now be made to FIG. 8 which shows a schematically a user equipment. The user equipment may provide for example a communication of data for carrying communications such as voice, electronic mail (email), text message, multimedia and so on.

With user equipment, users may be thus offered and provided with numerous services via their user equipment. Non-limiting examples of these services include two-way or multi-way calls, data communication or multimedia services or simply an access to the data communications network such as the Internet. A user may be provided by their user equipment with broadcast or multicast content. Non-limiting examples of the content include downloads, television and radio programs, videos, advertisements, various alerts and other information.

A user equipment 201 is typically provided wireless access via at least one access node such as a base station or similar wireless transmitter and/or receiver node of an access system.

FIG. 8 shows a schematic, partially sectioned view of an example of a user equipment 201 usable in conformance with certain embodiments of the present invention that a user can use for communication with a communication system. An appropriate mobile communication device may be provided by any device capable of sending and receiving radio signals. Non-limiting example include a mobile station (MS), a portable computer provided with a wireless interface card or other wireless interface facility, personal data assistant (PDA) provided with wireless communication abilities or any combinations of these or the like. A mobile communication device may be used for voice and video calls, for accessing service applications and so on. The user equipment 201 may receive signals via an air interface 211 via appropriate apparatus for receiving and may transmit signals via appropriate apparatus for transmitting radio signals. In FIG. 8, a transceiver is designated schematically by block 207. The transmitter may be provided, for example by means of a radio part and associated antenna arrangement. The antenna arrangement may be arranged internally or externally to the mobile device.

The user equipment is also typically provided with at least one data processing entity 203. The data processing entity can be any suitable processor. The processor may be a single processor, dual core or a multi core processor. The processing entity may be provided on a single integrated chip or provided over a plurality of integrated circuits (a so-called chip set). The user equipment also comprises at least one memory 204 and may include other processor components 209. One or more of the data processing entity, the memory and other processor components may be used in software aided execution of tasks, for example control of access 2 and communications with access systems and other communication devices. The memory and other processor components may be provided on one or more integrated circuits or may be provided by any other suitable circuitry. Where at least part of these entities is provided on an integrated circuits, these may be the same or different to those providing the data processing entity 203.

The data processing, storage and other relevant control apparatus can be provided on an appropriate circuit board, and/or in chip sets and/or provided by suitable circuitry. This feature is generated by reference 206.

The user may be able to control the operation of the mobile device by means of a suitable user interface and user interface circuitry. This may include, for example a keypad 202, voice commands, touch sensitive screen or pad, combinations thereof or the like. A display 205 and associated display software may be provided. Typically, a speaker and microphone may also be provided.

Furthermore, the user equipment comprises circuitry 214 which will permit the communication device 201 to make a short range connection with neighbouring user equipment. This circuitry is arranged to convert requests received from, for example, the processing entity into appropriate format for transmission. A separate antenna for the short range communication may be provided. Alternatively, the circuitry 214 may be arranged to share the main antenna of the user equipment.

The user equipment is provided with a battery 215 which will be connected to all parts of the user equipment which require a power supply.

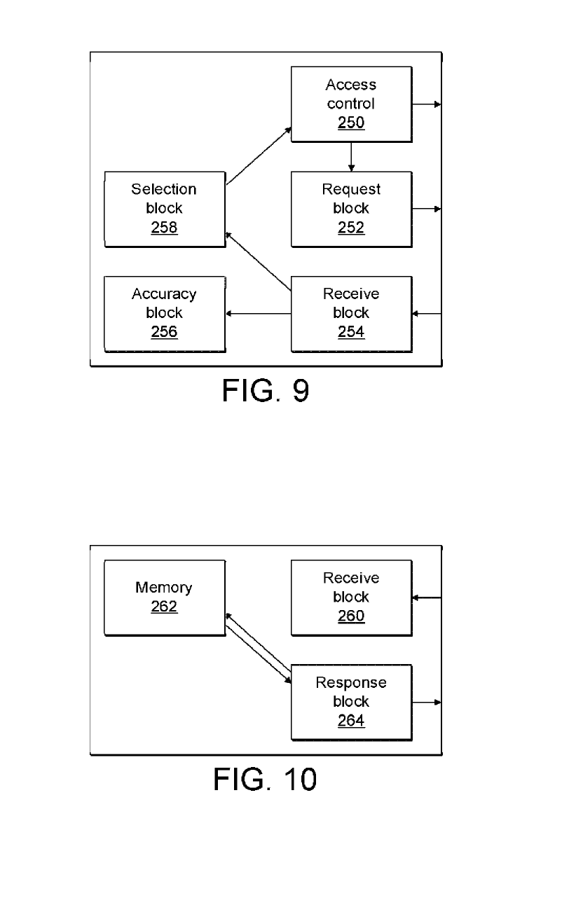

Reference is made to FIG. 9 which shows at least a part of the data processing entity 203 in more detail. The data processing entity comprises the following blocks: An access control block 250. This block is arranged to determine that a selection process is to be initiated. This access control block is arranged to cause a request block 252 to formulate a request which is to be sent out to neighbouring user equipment. The request block 252 sends a request to the circuitry 214 which up converts the request and processes the request accordingly into a format in which it can be transmitted from the user equipment.

Receive block 254 is arranged to receive responses from the neighbouring user equipment. It should be appreciated that the responses will be received from circuitry 214 which will have down converted the received responses. It should be appreciated that any encoding/decoding may take place in block 203, in circuitry 214, a combination of data processing entity 206 and circuitry 214 and/or elsewhere. Information received by the receive block 254 is output to the accuracy determination block 256 which is arranged to determine the accuracy of the measurements received from each user equipment, as outlined previously. The information relating to the accuracy is output to a selection block 258. The selection block 258 also receives the responses from the neighbouring user equipment form receive block 254. Based on the accuracy and the received responses, block 258 is arranged to select an appropriate access network as outlined previously. The selection block 258 provides an output to the access control block 250 which in response to the selection of the access network causes the user equipment to initiate the access procedure with the selected access network.

Reference is made to FIG. 10 which illustrates schematically the data processing entity of a user equipment in a neighbouring user equipment. This would be part of, for example the data processing entity. A received block 260 would be arranged to receive the request from the user equipment which is seeking to select an access network. This request would have been received via circuit 214. A memory block 262 is provided which stores measurement information. A response unit 264 is arranged to formulate a response to the user equipment based on the information included in the request and the stored signal strength. The response block 264 for example may use identity information included in the request message in order to include that information in the response. Additionally, the response block 264 may be arranged to include information identifying the access network for which the signal strength or the like relate.

In practice, a single user equipment may have the functional blocks of both FIGS. 9 and 10.

It should be appreciated that in FIGS. 9 and 10, the memory functions may be provided by a separate data store or as part of the other memory provided in the user equipment.

It should be appreciated that the blocks of FIGS. 9 and 10 may be circuitry or may be provided by software running on for example a processor or a combination thereof.

It should be appreciated that instead of user equipment, alternative embodiments of the invention can in fact be any other suitable communication device and for example may be used to report data or the like.

In some embodiments of the invention, a selection of a suitable access network is based on information which is received from user equipment which are nearby. This means that the battery energy consumption may be conserved as this process may use less energy than scanning the pilot signals or the like of all the available access networks.

One example of a method comprises receiving in a first mobile communication device information about at least one access network from at least one second mobile communication device, and selecting an access network for use by the first mobile communication device in dependence on said information.

One example of an apparatus comprises at least one processor and at least one memory including computer program code, the at least one memory and the computer program code configured to, with the at least one processor, cause the apparatus at least to perform: selecting an access network for use by a first mobile communication device in dependence on received information about at least one access network, said information being received from at least one second mobile communication device.

Another example of an apparatus comprises means for receiving in a first mobile communication device information about at least one access network from at least one second mobile communication device and means for selecting an access network for use by the first mobile communication device in dependence on said information.

As used in this application, the term “circuitry” refers to all of the following:

a) hardware-only circuit implementations (such as implementations in only analog and/or digital circuitry) and
b) to combinations of circuits and software (and/or firmware), such as (as applicable): i) to a combination of processor(s) or ii) to portions of processor(s)/software (including digital signal processors), software, and memory(ies) that work together to cause an apparatus, such as a mobile phone or server, to perform various functions) and
c) to circuits, such as microprocessor(s) or a portion of a microprocessors), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

1. A method comprising:
receiving in a first mobile communication device information about at least one access network from at least one second mobile communication device; and
selecting an access network for use by the first mobile communication device in dependence on said information.

2. A method as claimed in claim 1, comprising:
providing a request to be sent from said first mobile communication device to said at least one second mobile communication device.

3. A method as claimed in claim 2, comprising broadcasting said request to at least one second mobile communication device.

4. A method as claimed in claim 2, wherein said request comprises information identifying said first mobile communication device.

5. A method as claimed in claim 1, wherein said information comprises at least one of:
information about a strength of a signal received from an access network at a respective second mobile communication device; information about a capacity of an access network; information about free capacity of an access network; information about a network type; information about a network operator; information about signal quality; information about available services;
information about distance between said a respective second mobile communication device and said first mobile communication device; and information about distance between said at least one second user equipment and an associated access node.

6. A method as claimed in claim 1, comprising selecting an access network using a plurality of different types of information.

7. A method as claimed in claim 6, wherein one of said plurality of different types of information comprises the operator of a respective second mobile communication device.

8. A method as claimed in claim 6, comprising receiving information at the first mobile communication device from a plurality of second mobile communication devices, and said selection comprises giving a greater weight to information from said one or more second mobile communication devices associated with a same operator as the first mobile communication device.

9. A method as claimed in claim 6, comprising receiving information at the first mobile communication device from a plurality of second mobile communication devices, and said selection comprises only using information from said one or more second mobile communication devices associated with a same operator as the first mobile communication device.

10. A method as claimed in claim 6, wherein said plurality of different types of information comprises a distance between a respective second mobile communication device and an associated access node and a distance between said first mobile communication device and each of said second mobile communication devices.

11. A method as claimed in claim 1, comprising determining an accuracy of said information and selecting said access network based on said determination.

12. A method as claimed in claim 1 comprising receiving information about a first access network from at least one second mobile communication device and information about a second access network from at least one second mobile communication device.

13. Apparatus comprising:
at least one processor; and
at least one memory including computer program code, the at least one memory and the computer program code configured to, with the at least one processor, cause the apparatus at least to perform:
selecting an access network for use by a first mobile communication device in dependence on received information about at least one access network, said information being received from at least one second mobile communication device.

14. Apparatus as claimed in claim 13, wherein the at least one memory and the computer program code configured to, with the at least one processor, cause the apparatus to provide a request to be sent from said first mobile communication device to said at least one second mobile communication device.

15. Apparatus as claimed in claim 14, wherein the at least one memory and the computer program code is configured to, with the at least one processor, cause the apparatus cause the broadcasting said request to at least one second mobile communication device.

16. Apparatus as claimed in claim 14, wherein said request comprises information identifying said first mobile communication device.

17. Apparatus as claimed in claim 13, wherein said information comprises at least one of:
information about a strength of a signal received from an access network at a respective second mobile communication device; information about a capacity of an access network; information about free capacity of an access network; information about a network type; information about a network operator; information about signal quality; information about available services;
information about distance between said a respective second mobile communication device and said first mobile communication device; and information about distance between said at least one second user equipment and an associated access node.

18. Apparatus as claimed in claim 12, wherein the at least one memory and the computer program code is configured to, with the at least one processor, to cause the apparatus to select an access network using a plurality of different types of information.

19. Apparatus as claimed in claim 17, wherein one of said plurality of different types of information comprises the operator of a respective second mobile communication device.

20. Apparatus as claimed in claim 19, wherein the at least one memory and the computer program code is configured to, with the at least one processor, cause the apparatus at least to perform said selection in which greater weight is given to information from said one or more second mobile communication devices associated with a same operator as the first mobile communication device.

21. Apparatus as claimed in claim 19, wherein the at least one memory and the computer program code is configured to, with the at least one processor, cause the apparatus to only use information from said one or more second mobile communication devices associated with a same operator as the first mobile communication device when selecting said access network.

22. Apparatus as claimed in claim 19, wherein said plurality of different types of information comprises a distance between a respective second mobile communication device and an associated access node and a distance between said first mobile communication device and each of said second mobile communication devices.

23. Apparatus as claimed in claim 13, wherein the at least one memory and the computer program code is configured to, with the at least one processor, cause the apparatus to determine an accuracy of said information and select said access network based on said determination.

24. Apparatus comprising:
means for receiving in a first mobile communication device information about at least one access network from at least one second mobile communication device; and
means for selecting an access network for use by the first mobile communication device in dependence on said information.

25. Apparatus as claimed in claim 13, wherein said apparatus is comprised by an integrated circuit or chip set.

26. Apparatus as claimed in claim 13, wherein said apparatus is a mobile phone further comprising: user interface circuitry and user interface software configured to facilitate user control of at least some of the functions of the mobile phone through use of a display and configured to respond to user inputs and a display and display circuitry configured to display at least a portion of a user interface of the mobile phone, the display and display circuitry configured to facilitate user control of at least some of the functions of the mobile phone.

27. A memory comprising program code that, when executed by a processor, causes an apparatus to perform:
receiving in a first mobile communication device information about at least one access network from at least one second mobile communication device; and
selecting an access network for use by the first mobile communication device in dependence on said information.
